(19) United States
(12) Patent Application Publication
(10) Pub. No.: US 2018/0055614 A1
(43) Pub. Date: Mar. 1, 2018

(54) FLARED CONICAL DENTAL POST

(71) Applicants: National Guard Health Affairs, Riyadh (SA); King Saud bin Abdulaziz University for Health Sciences, Riyadh (SA); King Abdullah International Medical Research Center, Riyadh (SA)

(72) Inventor: Bassam Nawaf SRAYEDDIN, Rafha (SA)

(73) Assignees: National Guard Health Affairs, Riyadh (SA); King Saud bin Abdulaziz University for Health Sciences, Riyadh (SA); King Abdullah International Medical Research Center, Riyadh (SA)

(21) Appl. No.: 15/254,069

(22) Filed: Sep. 1, 2016

(51) Int. Cl. A61C 13/30; A61C 8/00

(52) U.S. Cl. CPC A61C 13/30; A61C 8/0089; A61C 8/0022; A61C 8/0086

(57) ABSTRACT

The present disclosure relates to a dental root post for restoration of a tooth, and a damping dental post key for implanting the dental root post. The dental post is configured to give enhanced retention to a tooth core as well as for final restoration materials and dental end caps and crowns. The dental post can be divided into a head portion configured to reconstruct the tooth core and rotate the dental root post during insertion and a root portion having different features depending on a depth required for the restoration. The root portion can have a set of grooves, a set of threads and a shape configured to distribute masticatory loading stress during mastication.

### BACKGROUND

### Field

The present disclosure relates to dental root posts having a radicular portion that is designed for insertion and cementing into a root canal area of a tooth, and a head portion that is designed to serve for reconstruction of a core and final restoration.

### SUMMARY

The present disclosure relates to a dental root post for restoration of a tooth, and a damping dental post key for implanting the dental root post. The dental post is configured to give enhanced retention to a tooth core as well as for final restoration materials and dental end caps and crowns. The dental post can be divided into a head portion configured to reconstruct the tooth core and rotate the dental root post during insertion and a root portion having different features depending on a depth required for the restoration. The root portion can have a set of grooves, a set of threads and a shape configured to distribute masticatory loading stress during mastication.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a perspective view drawing of a dental post that is divided into a head portion and a root portion, where the root portion includes an apical section including threads and a cervical section without threads according to an example;

FIG. 1B is a perspective view drawing of the dental post of FIG. 1A including grooves that extend to only the cervical section of the root portion according to an example;

FIG. 1C is a perspective view drawing of the dental post of FIG. 1A including grooves that extend to the entire root portion according to an example;

FIG. 2A is a perspective view drawing of a dental post that is divided into a head portion and a root portion, where the root portion includes an apical section without threads and a cervical section including threads according to an example;

FIG. 2B is a perspective view drawing of the dental post of FIG. 2A including grooves that extend to only the cervical section of the root portion according to an example;

FIG. 2C is a perspective view drawing of the dental post of FIG. 2A including grooves that extend to the entire root portion according to an example;

FIG. 3A is a perspective view drawing of a dental post that is divided into a head portion and a root portion, where the root portion includes a set of grooves, where each groove has a V-shape according to an example;

FIG. 3B is a perspective view drawing of a dental post that is divided into a head portion and a root portion, where the root portion includes a set of grooves, where each groove has a square-shape according to an example;

FIGS. 4A-4E are a set of examples of an extrusion profile forming a thread in a longitudinal axis;

FIGS. 5A-5I are drawings of a set of examples of a horizontal cross-section shape of a groove;

FIGS. 6A-6F show different perspective views of a head portion having a set of horizontal grooves, a pair of flat surfaces, and a slot configured to receive a dental post key according to an example;

FIGS. 7A-7F show different perspective views of the head portion of FIGS. 6A-6F having tapered shape along longitudinal axis according to an example;

FIGS. 8A-8D show different side, perspective, and cross-sectional views of a head portion having a set of horizontal grooves, a pair of flat surfaces, and a slot configured to receive a dental post key according to an example;

FIGS. 8E-8H show a cross-sectional and perspective view of the head portion shown in FIGS. 8A-8D further including a second set of vertical grooves along longitudinal axis that intersect the set of horizontal grooves according to an example;

FIGS. 9A-9D show different side, perspective, and cross-sectional views of a head portion having a square shape and a slot configured to receive a dental post key according to an example;

FIGS. 9E-9H show a cross-sectional and perspective view of the head portion shown in FIGS. 9A-9D further including a second slot that intersects the first slot according to an example;

FIGS. 10A-10K show different side, perspective, and cross-sectional views a dental post including the head portion of FIGS. 8A-8D and the root portion of FIG. 3A according to an example;

FIGS. 11A-11K show different side, perspective, and cross-sectional views a dental post including the head portion of FIGS. 8E-8H and the root portion of FIG. 3B according to an example;

FIGS. 12A-12M show different side, perspective, and cross-sectional views a dental post including the head portion of FIGS. 6A-6F and the root portion of FIG. 2B according to an example;

FIGS. 13A-13N show different side, perspective, and cross-sectional views a dental post including the head portion of FIGS. 7A-7F and the root portion of FIG. 1B according to an example;

FIG. 14A shows a perspective drawing of a dental post key including a body having a cover and a post carrier, protruding the cover, having a key shape configured to turn a respective dental post according to an example;

FIG. 14B shows a drawing of a dental post key, without the cover, including a set of springs configured to resist a force between the post carrier and the body according to an example;

FIG. 14C shows a drawing of a dental post key, without the cover, including a set of torsion springs configured to resist a force between the post carrier and the body according to an example;

FIG. 14D shows a drawing of a dental post key, without the cover, including a post carrier having a set of plate spring configured to resist a force between the post carrier and the body according to an example;

FIG. 14E shows a perspective drawing of expanded parts of the dental post key of FIG. 14B with cover according to an example;

FIG. 14F shows a perspective drawing of expanded parts of the dental post key of FIG. 14C with cover according to an example;

FIGS. 15A-15F show a series of perspective views of the post carrier of FIG. 14B according to an example;

FIGS. 16A-16G are a series of perspective views of the post carrier of FIG. 14C according to an example;

FIGS. 17A-17F are a series of perspective views of examples of the key shape of a post carrier configured to match a respective dental post;

FIG. 18 shows an example of a dental post key and a dental post of FIG. 1A that will implant into a prepared root canal of a tooth model in a clockwise direction according to an example;

FIG. 19A shows a cross-section view of an example of a tooth model having a root surrounded by periodontal ligament and bone, and restored with the dental post of FIG. 13B, core and crown according to an example;

FIG. 19B shows a cross-section view of a tooth model of FIG. 19A restored with the dental post of FIG. 12B, core and crown according to an example; and

FIG. 19C shows a cross-section view of a tooth model of FIG. 19A restored with the dental post of FIG. 10D, core and crown according to an example.

### DETAILED DESCRIPTION

The present disclosure relates to a dental root post for restoration of a tooth, and a damping dental post key for implanting a threaded dental post into a prepared root canal. The dental post is configured to give enhanced retention to a tooth core as well as for final restoration materials and end caps. The dental post can be divided into a head portion and a root portion, each having different features depending on a depth required for the restoration. The root portion is configured to have two conical level sections; a cervical flared shape section and apical conical section to obtain more adaptation to the root canal. The head portion can be configured to serve for reconstruction a core with a composite material or an amalgam or any permanent dental filling material. The dental post is preferably made from a metal such as stainless steel and titanium or an alloy such as Ni—Cr alloy, but can be any other suitable material. A root channel can be initially prepared by use of suitable instruments having a same shape and wider size (0.2 mm) of the root post. The dental root post can subsequently be implanted and secured to the tooth with dental cement.

Referring now to the drawings, wherein like reference numerals designate identical or corresponding parts throughout the several views.

### Dental Post Model 1

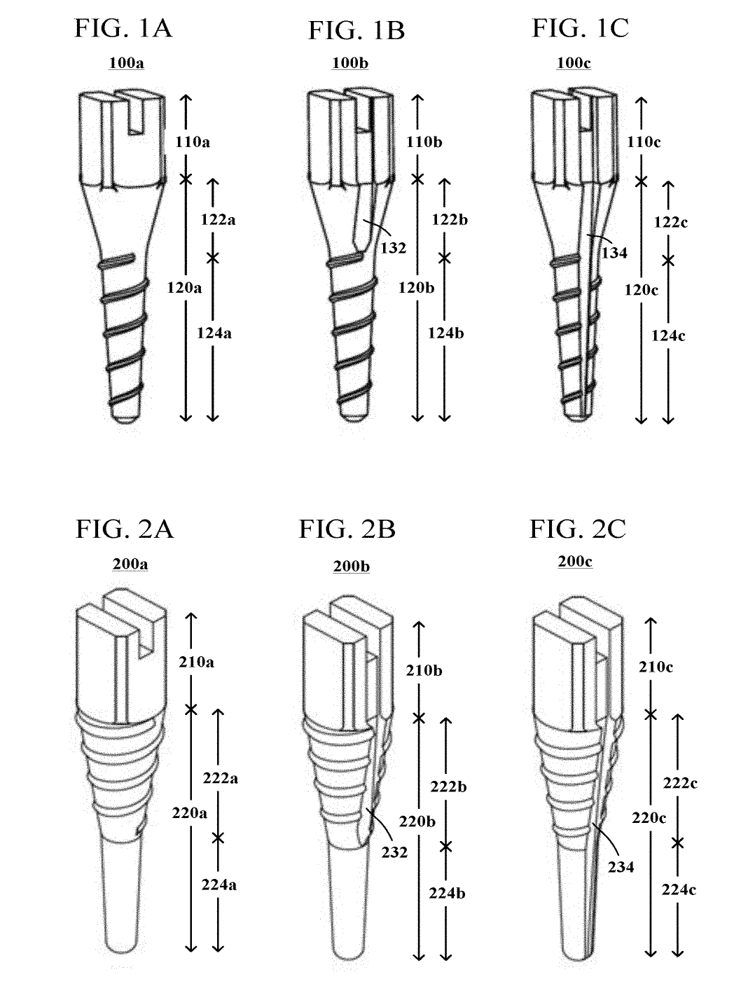

In a first embodiment, a dental post 100a-c can be divided into a head portion 110a-c and a root portion 120a-c. The root portion 120a-c includes a cervical section 122a-c having a flared shape and an apical section 124a-c having threads (See FIGS. 1A, 1B, 1C). The flared shape has a thickness such that mastication stress will be configured to concentrate on an upper or coronal part of the cervical section 122a-c. The apical section 124a-c is configured to give stabilization and allow conservation of a root tissue. The cervical section 122a-c is configured to give maximum support to a final restoration by transferring stress to the coronal part of the root tissue and to provide more protection from harmful stress on the apical root tissue.

The cervical section 122a-c is non-active (i.e. non-threaded) and flare shaped radially-decreasing conical axial profile along longitudinal axis between for example 6-18 degrees. The apical section 124a-c is active (i.e. threaded) tapered radially-decreasing conical axial profile along longitudinal axis between for example 1-5 degrees.

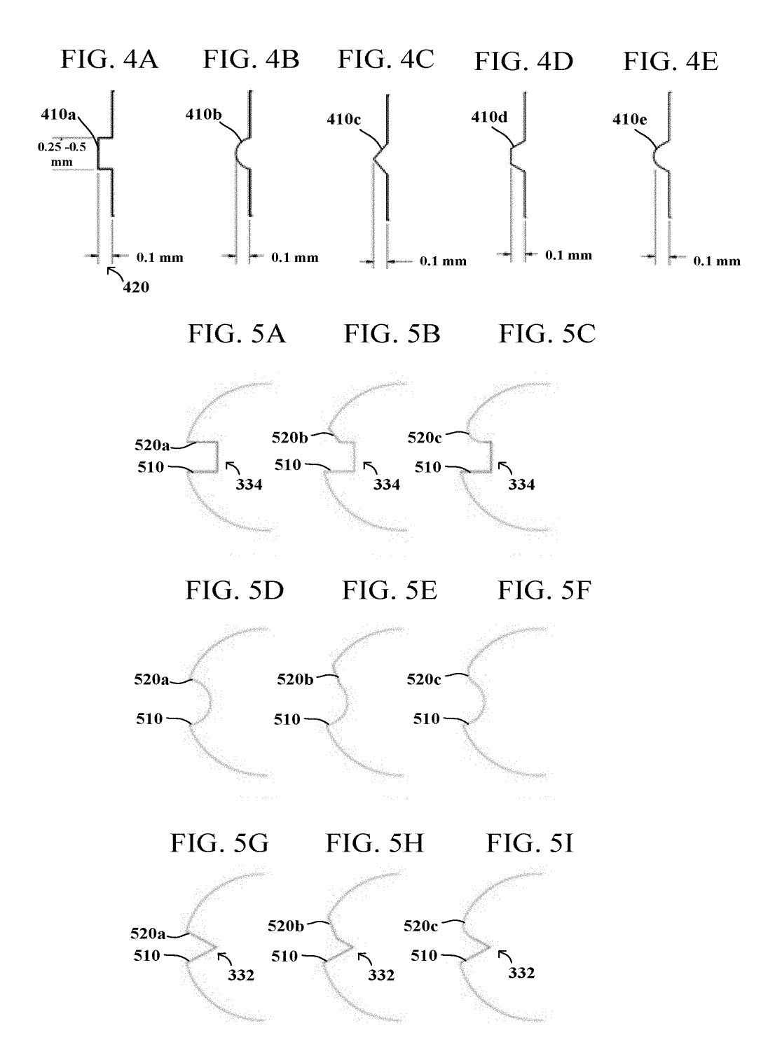

The dental post 100a-c is preferably used for roots having short-length and can have no grooves or 1 to 2 grooves. The grooves allow excessive cement to flow outside a tooth root canal and prevent from hydraulic pressure between the dental root post and the tooth's canal wall. The grooves can have different shapes as shown in FIGS. 5A-5I. The threads of the apical section 124a-c can be configured to serve as an anchor and can have different shapes with for example 0.1 mm height and for example 0.25 to 0.5 mm width, as shown in FIGS. 4A-4E.

FIG. 1A shows an example of a dental post 100a without groves. FIG. 1B shows an example of a dental post 100b including grooves 132 that extend to only the cervical section 122b of the root portion 120b. The grooves can extend to the entire root portion or only to the cervical section depending on the post sizes (i.e. length and diameter). In an example, the grooves can extend 0.5 to 1 mm diameter on cervical level. In an example, the grooves can extend 0.2 to 0.5 mm on the apex level. FIG. 1C shows an example of a dental post 100c including grooves 134 that extend to the entire root portion 120c.

### Dental Post Model 2

In a second embodiment, a dental post 200a-c can be divided into a head portion 210a-c and a root portion 220a-c that includes a cervical section 222a-c having a flared shape and threads, and an apical section 224a-c (See FIGS. 2A, 2B, 2C).

The cervical section 222a-c is active (i.e. threaded) and flare-shaped radially-decreasing conical axial profile along longitudinal axis between for example 6-18 degrees. The apical section 224a-c is non-active (i.e. non-threaded) tapered radially-decreasing conical axial profile along longitudinal axis between for example 1-5 degrees.

The dental post 200a-c can have no grooves or 1 to 4 grooves. The grooves can extend to the entire root portion or only to the cervical section, with 0.5 to 1 mm diameter on cervical level and 0.2 to 0.5 mm on the apex level, depending on the post sizes (i.e. length and diameter). The grooves allow excessive cement to flow outside the tooth root canal and prevent from hydraulic pressure. The grooves can have different shapes as shown in FIGS. 5A-5I. The threads of the cervical section 222a-c can be configured to serve as an anchor and can have different shapes with for example 0.1 mm height and for example 0.25 to 0.5 mm width, as shown in FIGS. 4A-4E.

FIG. 2A is an example of a dental post 200a without groves. FIG. 2B is an example of a dental post 200b including grooves 232 that extend to only the cervical section 222b of the root portion 220b. FIG. 2C is an example of a dental post 200c including grooves 234 that extend to the entire root portion 220c.

### Dental Post Model 3

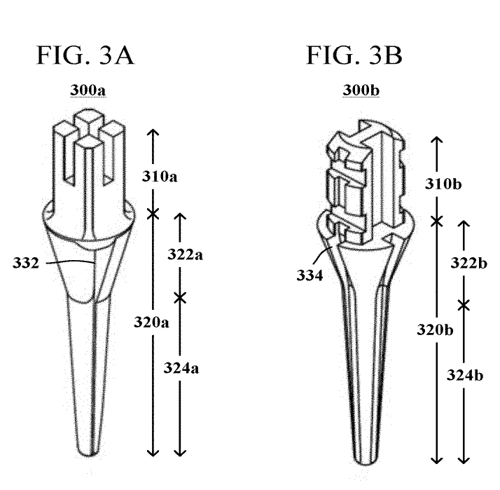

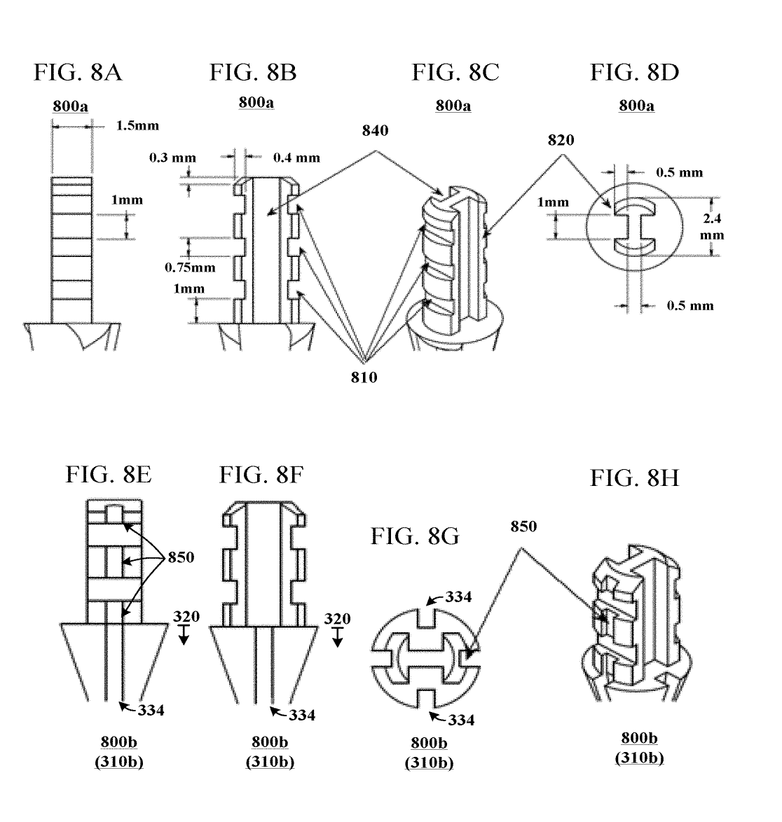

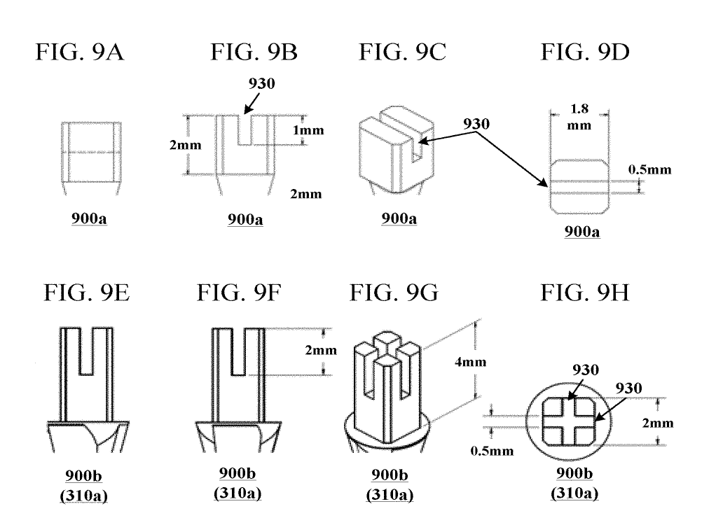

In a third embodiment, a dental post 300a-b includes a head portion 310a-b and a root portion 320a-b which includes a cervical section 322a-b and an apical section 324a-b (See FIGS. 3A, 3B). FIG. 3A is an example of a dental post 300a including a head portion 310a (See FIGS. 9E-9H) and a root portion 320a having three grooves, where each groove has a V-shape 332 (See FIGS. 5G-5I). FIG. 3B is an example of a dental post 300b including a head portion 310b (See FIGS. 8E-8H) and a root portion 320b having four grooves, where each groove has a square-shape 334 (See FIGS. 5A-5C). The cervical section 322a-b is non-threaded and has a flared-shape having a radially-decreasing conical axial profile along a longitudinal axis between for example 6-18 degrees. The apical section 324a-b is non-threaded tapered radially-decreasing conical axial profile along a longitudinal axis between for example 1-5 degrees. The dental post 300a-b can have no grooves or 1 to 4 grooves that extend to the entire root portion 320a-b.

The grooves can have a diameter and a depth which radially-decrease along a longitudinal axis of the dental post 300. The grooves can have different shapes as shown in FIGS. 5A-5I. Each groove can have a cutting active edge 510 in the clockwise direction and a non-active edge 520b-c in the counterclockwise direction. The cutting active edge 510 enables the dental post 300a-b to be inserted and placed into a root channel without using excessive force. Also during insertion of the dental post 300a-b, the cutting active edge 510 can be configured to allow soft self-drilling into the tooth root to give more retention and stabilization to the dental post 300a-b.

### Threads & Grooves

FIGS. 4A-4E show different examples of a cross-section of an extrusion profile 410a-e forming a thread. Each extrusion profile 410a-e can have an extrusion length 420. In an example, the extrusion length 420 can be 0.1 mm, but can also be any suitable length.

FIGS. 5A-5I show horizontal cross-sections of examples of the grooves. In an aspect, the groves can have a square shape (See FIGS. 5A, 5B, 5C), a curve shape (See FIGS. 5D, 5E, 5F), and a V-shape (See FIGS. 5G, 5H, 5I). In an aspect, the active edge 510 and non-active edge 520b-c of the groves can have a beveled edge 520b (See FIGS. 5B, 5E, 5H), or a fillet edge 520c (See FIGS. 5C, 5F, 5I).

### Head Portion Model 1

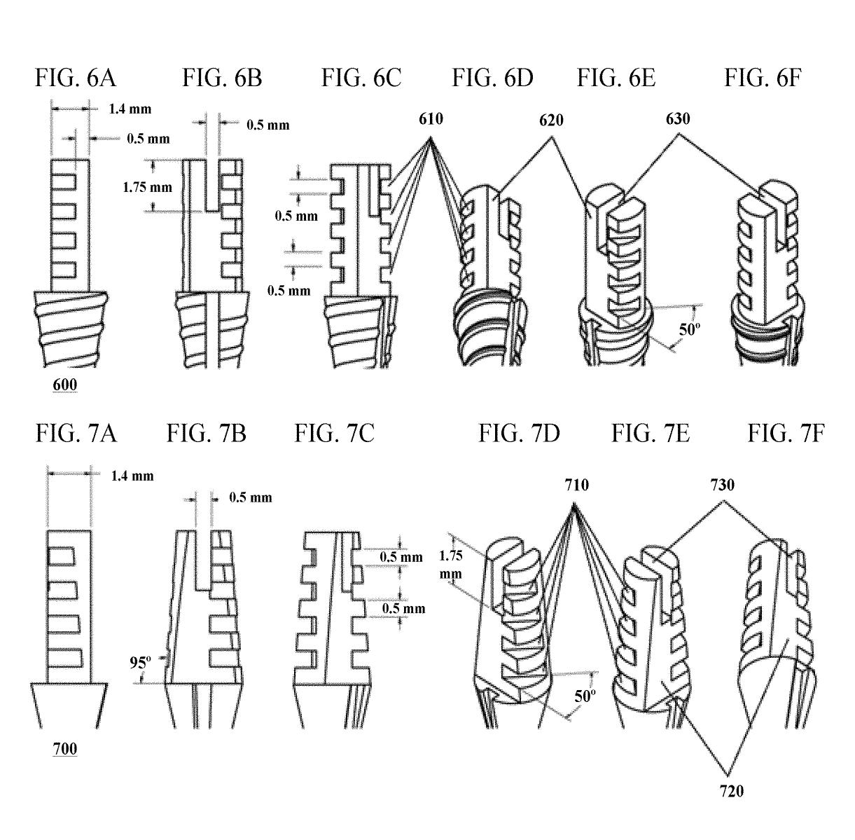

FIGS. 6A-6F show perspective views of examples of a head portion 600 having a set of horizontal grooves 610, a pair of flat surfaces 620, and a slot 630 configured to receive a dental post key. The head portion 600 can have a body with for example a circular cylindrical shape. FIGS. 7A-7F show perspective views of examples of a head portion 700 having a set of horizontal grooves 710, a pair of flat surfaces 720, and a slot 730 configured to receive a dental post key. The head portion 700 can have a body with circular tapered shape (e.g. 5 degree taper). Both the head portion 600 and the head portion 700 can have two flat surfaces 620, 720 along longitudinal axis, and a slot 630, 730 (e.g. 0.4 to 0.6 mm width and 1 to 2 mm height) configured to receive a respective dental post key for driving purposes. In horizontal direction, the head portion can include 2 to 8 grooves 610, 710 depending on a height of the head portion, and a 50 degree angle between the flat surface 620, 720 and the grooves 610, 710. In an example, the grooves 610, 710 can have a diameter of 0.5 to 0.75 mm. A total height of the head portion can vary between for example 2.5 to 6 mm.

### Head Portion Model 2

In a third example, FIGS. 8A-8H show perspective views of examples of a head portion 800a-b having a body with a circular cylindrical shape, a set of horizontal grooves 810, a pair of flat surfaces 820 along longitudinal axis, and a first set of vertical grooves 840 along longitudinal axis. Optionally, the head portion 800b can have a second set of vertical grooves 850 (See FIGS. 8E-8H). The optional additional vertical grooves 850 can have a groove diameter (e.g. 0.5 mm) based on a head size and a head diameter. In an example, the first set of vertical grooves 840 along longitudinal axis can have a 1 mm diameter. In an example, the set of horizontal grooves 810 can include 2 to 8 corresponding grooves 810, each with a 0.5 to 0.75 mm diameter, based on a height of the head portion 800. The height of the head portion 800a-b can vary between 3 to 7 mm.

### Head Portion Model 3

FIGS. 9A-9H show side and perspective views of examples of a head portion 900a-b. The head portion 900a-b can include a horizontal section having a square shape and either one slot 930 (See FIGS. 9A-9D) or two slots 930 (See FIGS. 9E-9H) for inserting a respective key for driving purposes. The horizontal section can have a width of 1.8 to 2.5 mm and a height of 2 to 4 mm. Each slot 930 can have a width of 0.4 to 0.6 mm and a height of 1-2 mm according to an example.

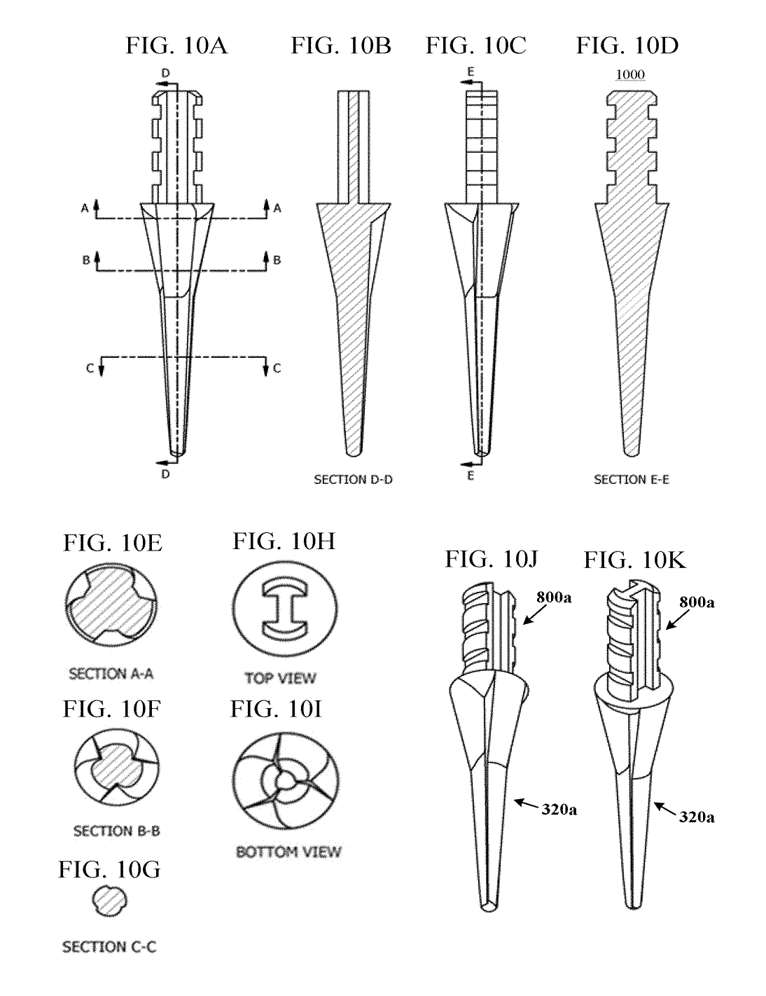

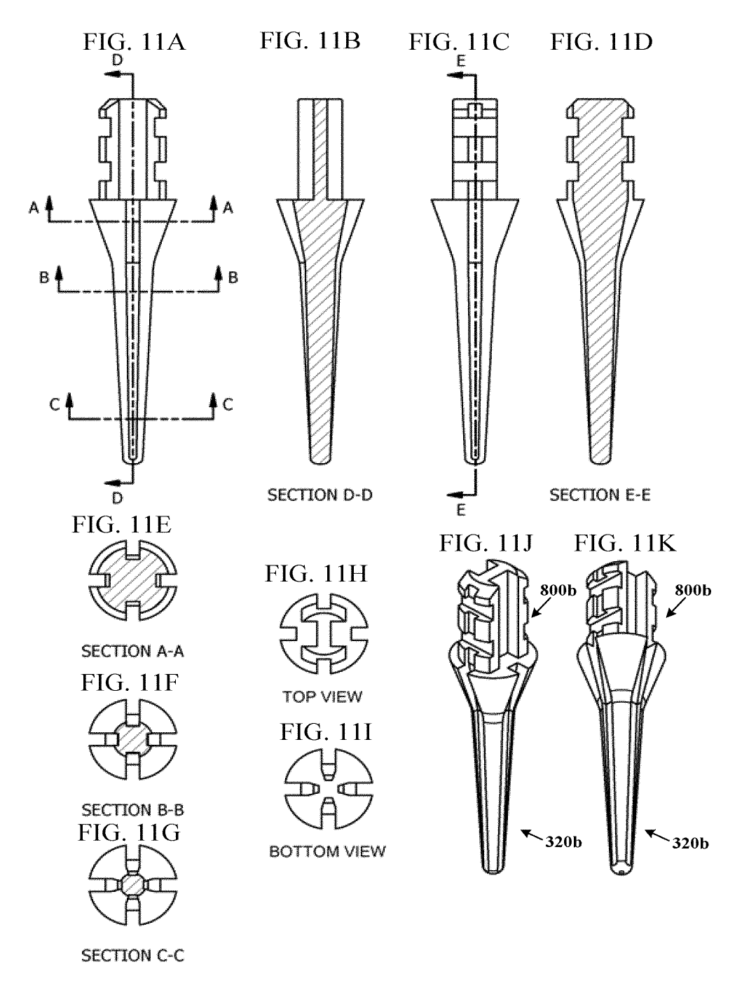

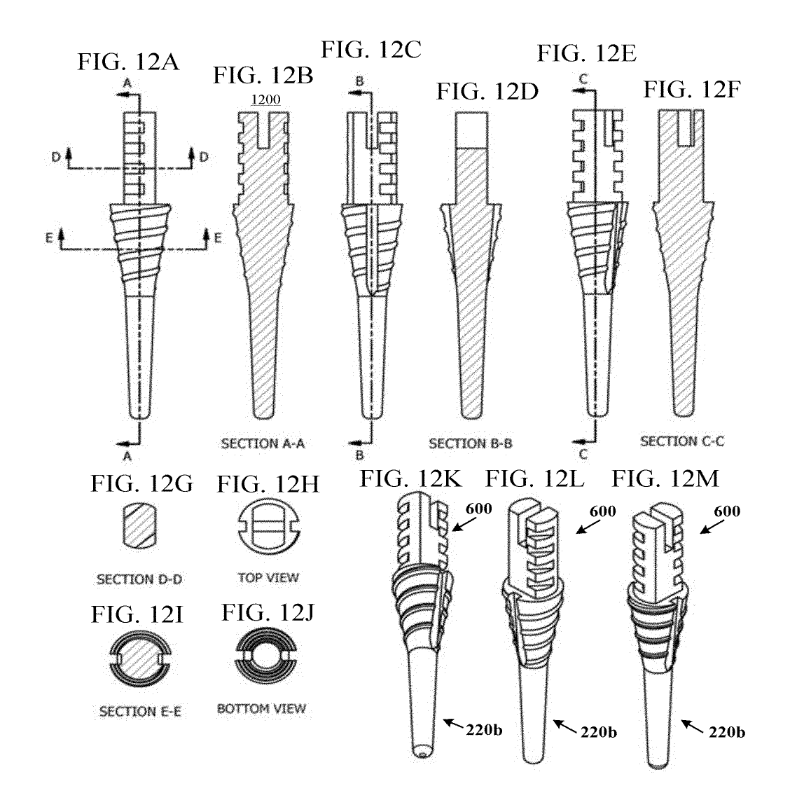

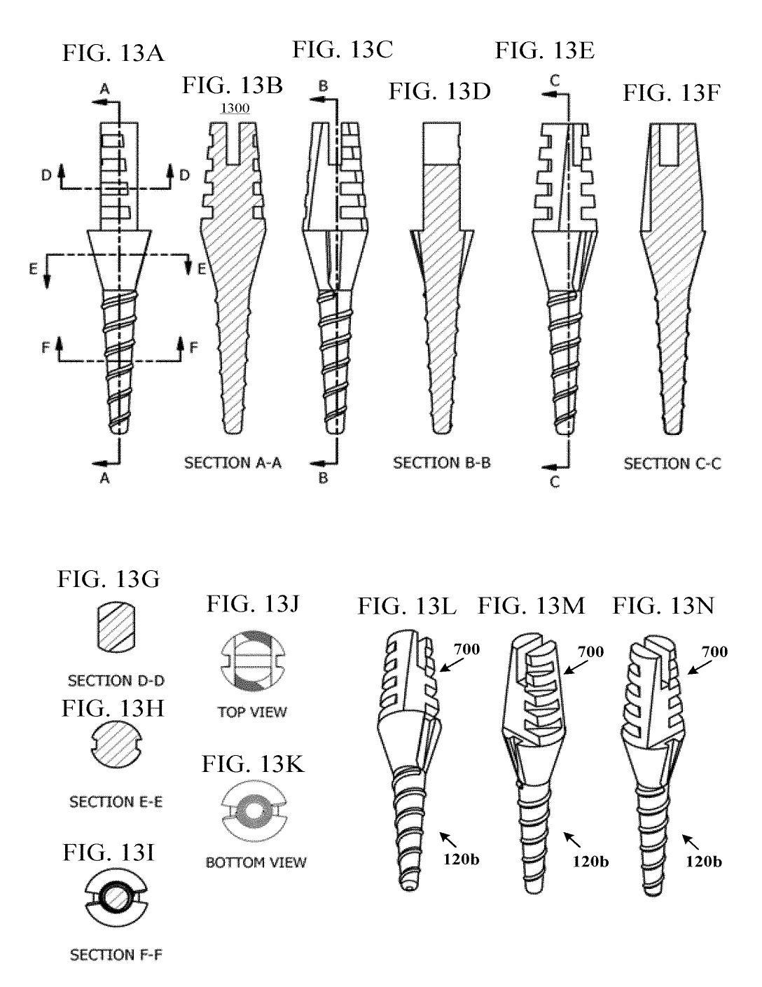

FIGS. 10A-10K are of cross-sectional and perspective views of an example of a dental post including the head portion 800a (FIGS. 8A-8D) and the root portion 320a (FIG. 3A). FIGS. 11A-11K are of cross-sectional and perspective views of an example of the dental post 300b, which includes the head portion 800b (FIGS. 8E-8H) and the root portion 320b (FIG. 3B). FIGS. 12A-12M are of cross-sectional and perspective views of an example of a dental post including the head portion 600 (FIGS. 6A-6F) and the root portion 220b (FIG. 2B). FIGS. 13A-13N are of cross-sectional and perspective views of an example of a dental post including the head portion 700 (FIGS. 7A-7F) and the root portion 120b (FIG. 1B). Obviously, different combinations of the different head portions and the different root portions are possible and are within the spirit and the scope of the present embodiments. FIGS. 19A-19C show cross-sectional views of an example of a tooth model having a tooth root 1810 surrounded by a periodontal ligament 1830 and a bone 1840. The tooth model is shown restored with different root posts 1300, 1200, 1000 (See FIGS. 13B, 12B, 10D), core 1920 and crown 1910.

### Dental Post Key

During implantation of a dental post, a dental post key can be used to create a smooth reaction force to implant a threaded dental post into the tooth root. In this way a limited force will be applied and a root fracture can be prevented. Further, the dental post key can be configured to have a fixed movement in a counterclockwise direction to remove the dental post and a free quarter-cycle movement with effort in a clockwise direction.

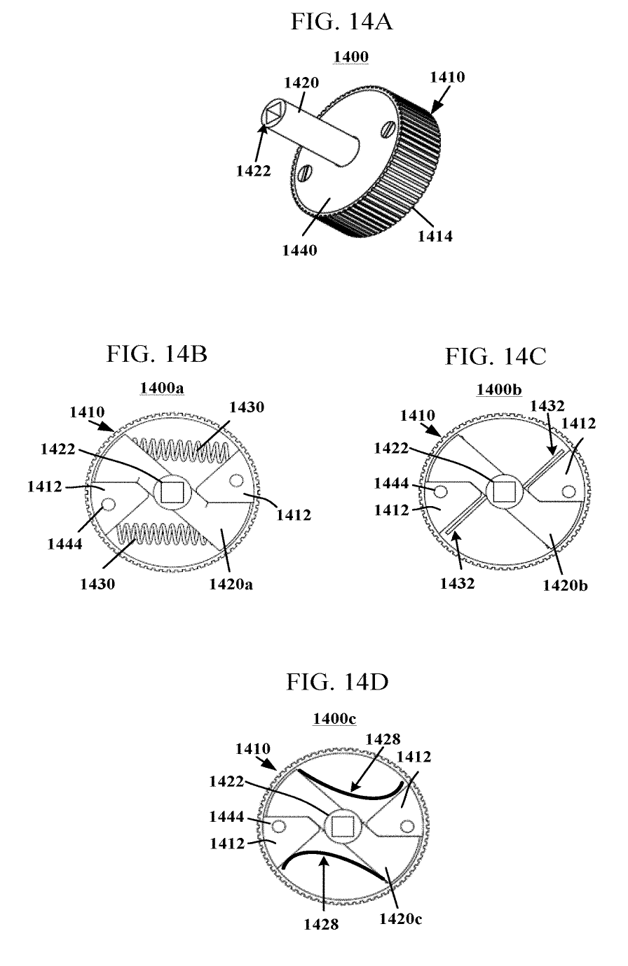

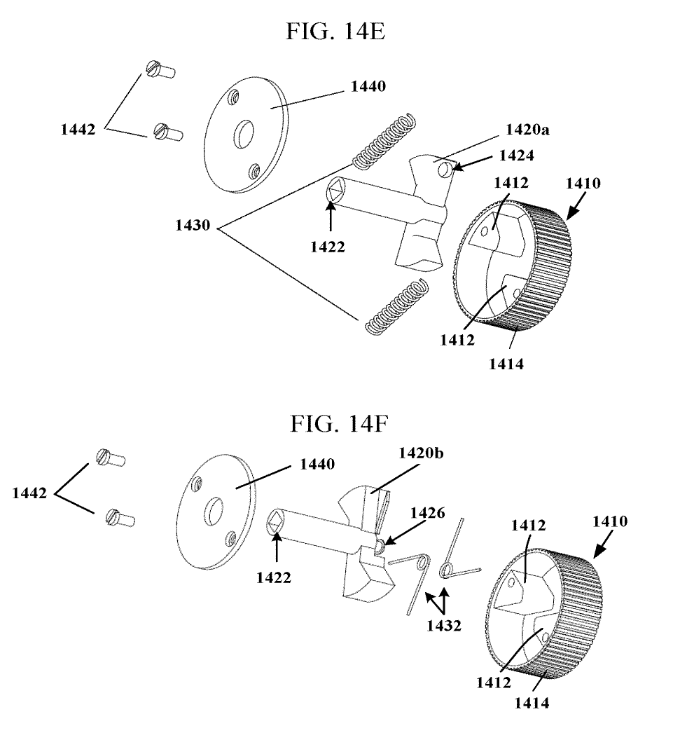

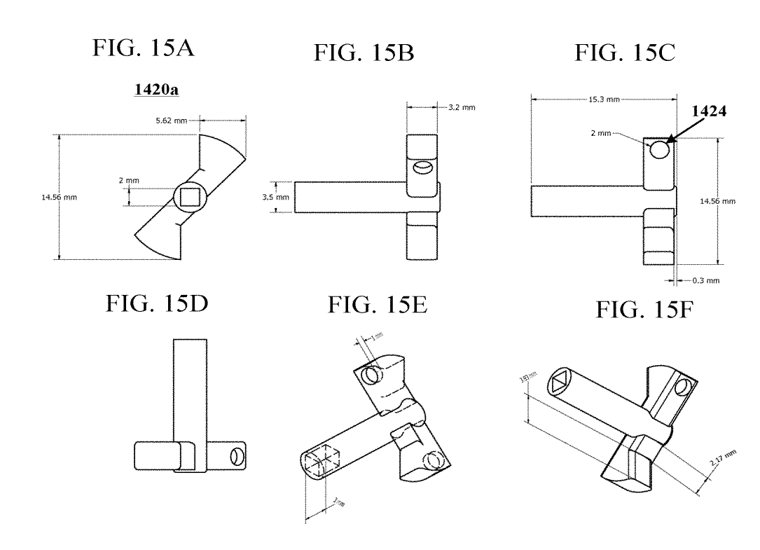

FIG. 14A shows a perspective drawing of a dental post key 1400 including a body 1410 for handling and a post carrier 1420 having a distal end with a key shape 1422 configured to turn a respective dental post. The dental post key 1400 is shown with a cover 1440 for the body 1410 with a central opening configured to allow a portion of the post carrier 1420 to pass through. The body 1410 can have a plurality of ridges 1414 on an outer surface configured to enhance gripping by an operator. A proximal end of the post carrier has an elongated shape. The body includes a pair of abutments 1412 configured to prevent the post carrier from rotating. Each abutment 1412 can include a threaded hole 1444 configured to receive a screw, such that the cover 1440 can be secured by a set of screws 1442 to each abutment 1412 according to an example.

In an example, a dental post key 1400a can include a set of springs 1430 that are configured to connect, or resist a force between, a post carrier 1420a to the body 1410 (See FIGS. 14B, 14E). Alternatively, the dental post key 1400a can include only one spring 1430 configured to connect the post carrier 1420a to the body 1410. In an example, each spring can be configured to have a different spring constant. In an example, a dental post key can include a first spring having a first spring constant and a second spring having a second spring constant. In an example, the second spring constant is substantially different than the first spring constant such that, when the dental post key is rotated, each spring is configured to create a dynamic reaction force to implant the dental root post into the tooth root.

FIG. 14E shows a perspective drawing of expanded parts of the dental post key of FIG. 14B according to an example. The post carrier 1420a and the two abutments 1412 having a set of securing areas (e.g. holes) 1424 configured to secure the set of springs 1430. FIGS. 15A-15F show a series of perspective views of an example of the post carrier 1420a.

In an example, a dental post key 1400b can include a set of torsion springs 1432 that are configured to connect, or resist a force between, a post carrier 1420b to the body 1410 (See FIGS. 14C, 14F). FIG. 14F shows a perspective drawing of expanded parts of the dental post key of FIG. 14C according to an example. The post carrier 1420b is shown having a knob 1426 configured to secure the set of torsion springs 1432. The knob 1426 can be recessed into the proximal end of the post carrier 1420b.

In an example, a dental post key 1400c can include a post carrier 1420c having at least one plate spring 1428 that is configured to connect, or resist a force between, the post carrier 1420c to the body 1410 (See FIG. 14D). In an example, the plate spring 1428 can be an extension of a shape of the post carrier 1420c. In another example, the spring 1428 can be a separate piece.

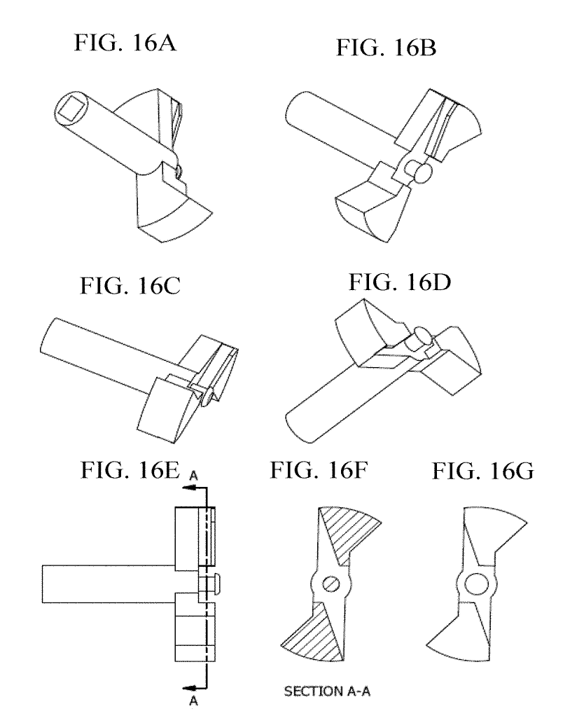

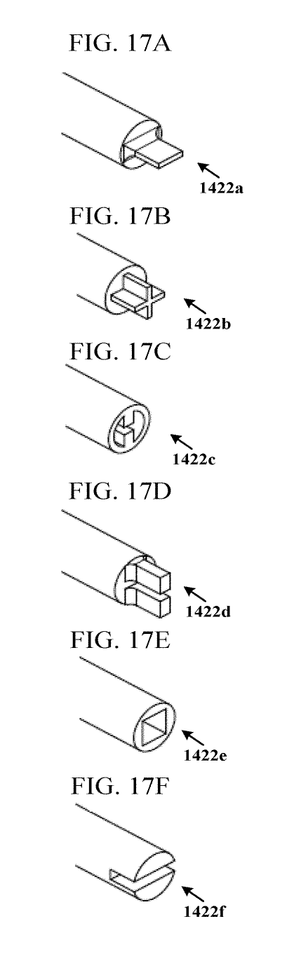

FIGS. 16A-16G are a series of perspective views of an example of the post carrier 1420b. FIGS. 17A-17F are a series of perspective views of examples of a key shape of a post carrier configured to match a respective dental post.

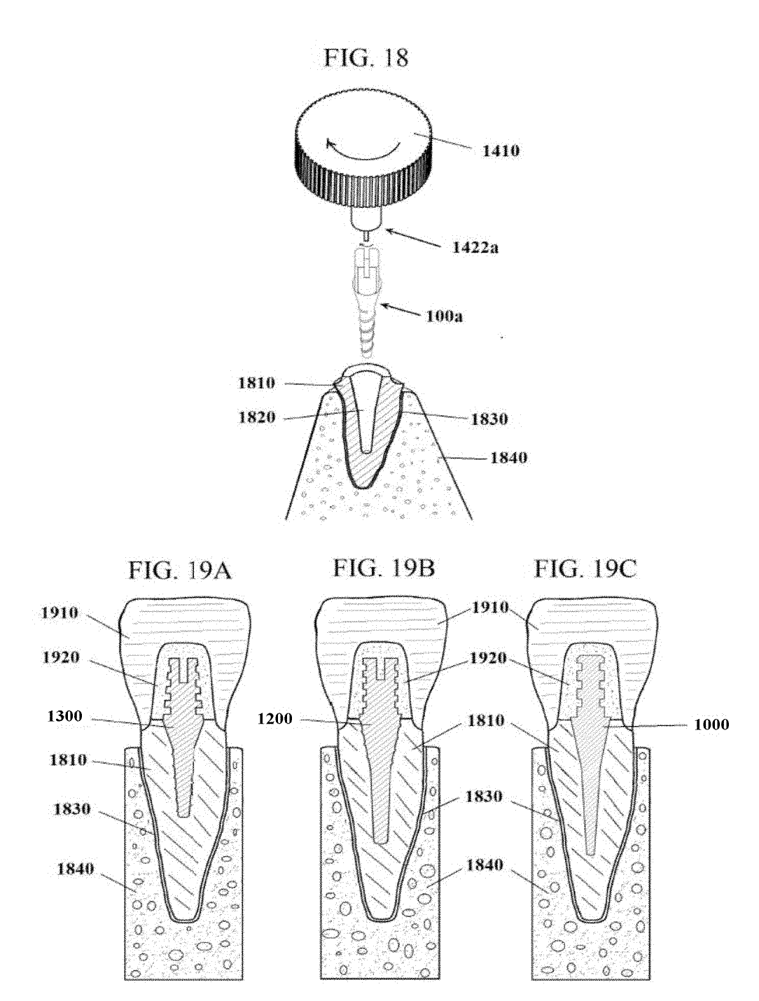

FIG. 18 shows an example of a dental post key with the post carrier 1422a (see FIG. 17A), and the post model 100a (see FIG. 1A) that is configured to be implanted into a prepared root canal 1820 of a tooth root 1810 in clockwise direction. The cross-sectional view of the tooth model shows the tooth root 1810 surrounded by the periodontal ligament 1830 and the bone 1840.

Obviously, numerous modifications and variations of the present invention are possible in light of the above teachings. It is therefore to be understood that within the scope of the appended claims, the invention may be practiced otherwise than as specifically described herein.

1. A dental root post for reconstruction of a tooth core and distribution of a masticatory loading stress during mastication, comprising:
a head portion configured to reconstruct the tooth core and rotate the dental root post during insertion; and
a root portion, connected to the head portion, having a cervical section and an apical section,
wherein, during mastication, a masticatory loading stress is configured to be transferred to a coronal region of the root portion.

2. The dental root post of claim 1, wherein the head portion includes at least one flat surface along a longitudinal axis of the dental root post.

3. The dental root post of claim 1, wherein the head portion includes a plurality of horizontal groves.

4. The dental root post of claim 1, wherein the head portion includes at least one slot configured to receive a dental post key.

5. The dental root post of claim 1, wherein the head portion includes a plurality of vertical grooves.

6. The dental root post of claim 1, wherein the head portion has a tapered shape along a longitudinal axis of the dental root post.

7. The dental root post of claim 1, wherein the cervical section includes a set of grooves along a longitudinal axis of the dental root post.

8. The dental root post of claim 1, wherein the cervical section includes a set of threads along a longitudinal axis of the dental root post.

9. The dental root post of claim 1, wherein the cervical section includes a flare-shaped radially-decreasing conical axial profile along a longitudinal axis of the dental root post.

10. The dental root post of claim 7, wherein the flare-shaped radially-decreasing conical axial profile is between 6-18 degrees.

11. The dental root post of claim 1, wherein the apical section includes a tapered radially-decreasing conical axial profile along a longitudinal axis of the dental root post.

12. The dental root post of claim 11, wherein the tapered radially-decreasing conical axial profile is between 1-5 degrees.

13. The dental root post of claim 1, wherein the apical section includes a set of grooves along a longitudinal axis of the dental root post.

14. The dental root post of claim 1, wherein the apical section includes a set of threads along a longitudinal axis of the dental root post.
